(19) United States
(12) Patent Application Publication
(10) Pub. No.: US 2006/0082849 A1
(43) Pub. Date: Apr. 20, 2006

(54) Image processing apparatus

(75) Inventor: Toshihiko Kaku, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/253,718

(22) Filed: Oct. 20, 2005

(30) Foreign Application Priority Data
Oct. 20, 2004 (JP) 305638/2004

(51) Int. Cl. H04N 1/46

(52) U.S. Cl. 358/537

(57) ABSTRACT

A local region determining section determines a region above a face, detected by a face detecting section, to be a local region, which is a part of a shadowless background region. An extraction executing section extracts regions adjacent to the local region and constituted by pixels of a similar color to that of the local region, as the shadowless background region. A shadow region extracting section extracts a region adjacent to the shadowless background region and constituted by pixels, of which: differences in hue and saturation from the average hue and the average saturation of the local region are within predetermined threshold values; the brightness is lower than the average brightness of the local region; and the difference in the brightnesses exceeds a predetermined threshold value, as a shadow region. A correcting section corrects the brightness of the shadow region to match that of the local region, to remove a shadow.

### BACKGROUND OF THE INVENTION

1. Field of the Invention

The present invention relates to an image processing apparatus for detecting shadows within photographic images, and to an image processing apparatus for removing shadows, which are detected within photographic images.

2. Description of the Related Art

Processes for removing shadows from photographic images are necessary in various fields. For example, in the field of ID photographs, there are no problems in the case that an ID photograph is photographed at a photography studio, in which equipment such as illumination equipment, are provided. However, in the case that a simple apparatus is employed to photograph an ID photograph, shadows may appear on a background, in the vicinity of a subject, which is a foreground object (an upper body of a human including the face, in the case of an ID photograph). It is necessary to remove the shadows if photographic images obtained in this manner are to be utilized as ID photographs.

Japanese Unexamined Patent Publication Nos. 7(1995)-220049 and 2001-209809 disclose techniques for removing shadows from photographic images. Japanese Unexamined Patent Publication No. 7 (1995)-220049 discloses a technique in which logic operations are administered on a background image, that is, an image obtained by photographing a background without a foreground object, and an image with a foreground object. Thereby, a region in which the shadow of a main subject appears on the background is detected and removed. Japanese Unexamined Patent Publication No. 2001-209809 discloses a technique in which a difference image is obtained between a background image (an image without a foreground object) and an image with a foreground object. A shadow region is estimated from within the difference image and removed.

Both of the above techniques require the background image, that is, the image obtained by photographing the background without the foreground object. Therefore, it is necessary to perform photography twice in order to remove shadows from photographic images, which is time consuming and troublesome. Consider a case in which a company, which has offices scattered throughout the country issues photo ID cards for its employees. The locations at where photography is performed (photography points) and the location at which the ID cards are actually generated (card issuing center) may be different. A system may be employed, in which photographic images may be obtained by performing photography at a plurality of photography points then sent to the card issuing center, and cards are generated at the card issuing center by employing the photographic images. In this case, it is difficult to obtain background images of all of the photography points, and if the background images are not obtained, then shadows cannot be removed from the photographic images.

### SUMMARY OF THE INVENTION

The present invention have been developed in view of the foregoing circumstances, and it is an object of the present invention to provide an image processing apparatus which is capable of detecting and removing shadows from photographic images without requiring background images.

A first image processing apparatus of the present invention is an image processing apparatus for removing shadows of a main subject, from a photographic image in which the shadows are present within a background having a simple pattern, comprising:

shadowless background region extracting means for extracting a shadowless background region, in which the shadows are not present, from the photographic image;

shadow region extracting means for extracting a shadow region, from regions within the photographic image other than the shadowless background region; and

correcting means, for removing the shadows from the photographic image, by adjusting pixel values of the shadowless background region and/or the shadow region.

The “photographic image” in the present invention refers to a photographic image of the main subject in front of a background having a simple pattern. The photographic image is not limited to that obtained by photography with a digital camera, and may include those obtained by reading out photographic film or prints with a readout apparatus, such as a scanner.

The “shadows” in the present invention refers to shadows of the main subject, which are present within the background, which excludes the main subject. For example in the case of the photographic image illustrated in FIG. 19, Region A and Region B constitute a background region (a background region that includes a shadow), and Region C constitutes a main subject (an upper body of a human including the face, in the example of FIG. 19). A shadowless background in the example of FIG. 19 is Region A, which is a region other than the main subject (i.e., the background region), from which a shadow region (Region B in the example of FIG. 19) is removed. Note that in the example of FIG. 19, the shadow region (Region B) is adjacent to the main subject region (Region C). However, the shadow region is not necessarily adjacent to the main subject region, depending on the angle of lighting, the position of the main subject within the photographic image and the like. For example, consider a case that a photograph of the entire body of a person is obtained by photographing the person in front of a background screen with lighting from the upper right to the lower left. In this case, there is a possibility that a shadow region will be present that extends from the lower left (in the case that the photograph is observed; actually the lower right side of the person), for example, the person's right knee, to the upper left portion of the photograph. However, if the upper half of the person's body is cut out from this photograph to be employed as the photographic image, the shadow region is not adjacent to the main subject. Therefore, in the photographic image, the shadow region and the main subject (the upper half of the person's body) are not adjacent. The “shadows” in the present invention include these types of shadows as well.

The first image processing apparatus of the present invention first extracts a shadowless background region, such as Region A of FIG. 19, from a photographic image. Then, a shadow region is extracted from regions other than the shadowless background region.

Generally, in illuminated photographic images in which subjects are pictured from the shoulders up, the shadow regions and the shadowless background regions are adjacent to each other. However, there are cases in which the shadow regions and the shadowless background regions are not adjacent to each other. For example, if a photographic image is obtained by photographing a person who has placed a hand at their waist, a background region is formed within the loop formed by the person's arm and their body. In this photographic image, there are cases that the shadow region is formed within the loop, due to lighting conditions and the like. In these cases, the shadow region within the loop and the shadowless background region outside the loop sandwich the subject's arm, and therefore are not adjacent to each other. The “shadow region extracting means” of the image processing apparatus of the present invention may be configured to be able to extract shadow regions in special cases such as these. However, it is preferable to extract the shadow regions from regions adjacent to the shadowless background region, in order to accurately and expediently extract the shadow regions, particularly from illuminated photographic images.

Here, the “shadowless background region extracting means” may comprise: local region obtaining means for obtaining a local region within the shadowless background region. In this case, the shadowless background region is extracted by obtaining regions adjacent to the obtained local region having pixels of similar colors to that of the local region, and by combining the local region with the adjacent regions.

The “local region” refers to a portion of the shadowless background region. In the case that the background is monochromatic or has no pattern therein, a single pixel will suffice as the local region. However, in the case that the background is a simple pattern, such as wood grain, polka dots, or a lattice, it is desirable that the local region includes at least a single pattern therein.

The phrase “having pixels of similar colors” refers to a state in which the pixels are at distances less than or equal to a predetermined threshold value within a chromaticity diagram, from pixels of the local region. For example, pixels having substantially the same chromaticity, saturation, and brightness, or pixels having substantially the same R, G, and B values, are considered to be pixels having similar colors.

The phrase “regions . . . having pixels of similar colors to that of the local region” refers to regions constituted by pixels having colors similar to pixels within the local region. For example, in the case that the local region is constituted by a single pixel, the regions may be those constituted by pixels having substantially the same pixel values (hue, saturation, brightness, or R, G, and B values) as the pixel of the local region. On the other hand, in the case that the local region is constituted by a plurality of pixels, average pixel values of the plurality of pixels that constitute the local region may be employed as a reference. In this case, the regions are those constituted by pixels, the differences in pixel values thereof from the reference values being within a predetermined threshold value. Average pixel values may be obtained for each pixel block, constituted by a plurality of pixels, and the regions determined to be those constituted by pixel blocks having substantially the same average pixel values as that of the local region.

A second image processing apparatus of the present invention is an image processing apparatus for removing shadows of a main subject, from a photographic image in which the shadows are present within a background having a simple pattern, comprising:

background region extracting means for extracting a background region, in which the shadows are present, from the photographic image;

shadow region extracting means for separating the extracted background region with shadows therein into a shadowless background region without shadows therein and a shadow region, in which the shadows are present; and

correcting means, for removing the shadows from the photographic image, by adjusting pixel values of the shadowless background region and/or the shadow region.

That is, the first image processing apparatus of the present invention extracts the shadowless background region (Region A, in the example illustrated in FIG. 19) and then extracts the shadow region (Region B, in the example illustrated in FIG. 19) from regions other than the shadowless background region. In contrast, the second image processing apparatus of the present invention extracts a background region, in which the shadows are present (Region A and Region B, in the example illustrated in FIG. 19), from the photographic image. Then, the shadow region is extracted, by separating the background region into a shadowless background region (Region A indicated in FIG. 19) and the shadow region (Region B indicated in FIG. 19).

In the second image processing apparatus of the present invention, the background extracting means may comprise local region obtaining means for obtaining a local region within a shadowless portion of the background region. In this case, the background region is extracted by obtaining regions adjacent to the obtained local region having pixels of similar colors to that of the local region, and by combining the local region with the adjacent regions.

Here, the “local region” is the same as that which has been described previously.

In backgrounds having simple patterns, the hue and/or the saturation among pixels are substantially the same regardless of whether the pixels are within shadow regions or shadowless regions. The second image processing apparatus of the present invention takes advantage of this point, and obtains regions of pixels having substantially the same hue and/or saturation as the local region (including the local region) as the background region. That is, the entire background region that excludes the foreground object, which is the main subject, is first extracted in this manner.

It is desirable that regions of pixels having substantially the same hue and saturation as those of the local region are obtained during extraction of the shadow region. If this configuration is adopted, backgrounds of various colors can be dealt with. However, in cases that the color of the background is known, then either the hue or the saturation only may be employed. For example, in the case that the background is gray, only the saturation may be employed to extract a shadow region constituted by pixels having substantially the same saturation value as that of pixels within the local region.

The local region obtaining means of the first and second image processing apparatuses of the present invention may be any means that is capable of obtaining a portion of the shadowless background region. For example the local region obtaining means may comprise face detecting means, in the case that the photographic image is an ID photo of a person. In this case, the local region can be obtained based on a facial region detected by the face detecting means.

In the case of ID photos, it is rare that shadows are formed above the central portion of a person's face. Therefore, the facial region may be detected by the face detecting means, and a portion of the photographic image above the central portion of the facial region, excluding the facial region, may be designated as the local region. Alternatively, a portion of the photographic image above the detected facial region may be designated as the local region.

Alternatively, the local region obtaining means may comprise input means, for specifying the local region. In this case, the local region may be obtained based on input, which is input via the input means.

The shadow region extracting means of the first image processing apparatus of the present invention extracts the shadow region from regions other than the shadowless background region. In contrast, the second image processing apparatus of the present invention extracts the shadow region, by separating the background region into the shadowless background region and the shadow region. Specifically, pixels of the shadowless background region and pixels of the shadow region have substantially the same hue and/or saturation values. However, the brightness of the pixels within the shadow region is lower than that of the pixels within the shadowless background region. Utilizing this fact, a region that has substantially the same hue and/or saturation and a lower brightness than the shadowless background region can be extracted as the shadow region.

The correcting means of the image processing apparatuses of the present invention removes shadows by adjusting the pixel values of pixels within the shadowless background region and/or the shadow region. Pixel values of both the shadowless background region and the shadow region, or pixel values of either one of the two regions can be adjusted, as long as the pixel values of the shadowless background region and the pixel values of the shadow region are matched. For example, the brightness of the pixels within the shadow region may be adjusted to match that of the shadowless background region, the brightness of the pixels within both the shadow region and the shadowless background region may be adjusted to be a predetermined brightness, or the brightness of the pixels within the shadowless background region may be adjusted to match that of the shadow region.

The methods of extracting shadow regions by the image processing apparatuses of the present invention is not limited to applications in which shadow regions are to be removed from photographic images, and may be applied to any purpose in which extraction of shadow regions is necessary. For example, in the field of specifying photography times from photographic images, the photography time can be specified by extracting the shadow region from a photographic image having a building, of which the position and the like are known, as the background.

The image processing apparatuses of the present invention may be provided as programs that cause a computer to execute the procedures performed thereby. That is, programs may be provided that cause a computer to function as the image processes apparatuses of the present invention.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object, and executable code, and can be in any language, including higher level languages, assembly language, and machine language.

The first image processing apparatus of the present invention extracts the shadowless background region from a photographic image, extracts the shadow region based on the shadowless background region, and removes the shadow from the photographic image. The second image processing apparatus of the present invention extracts the background region from a photographic image, extracts the shadow region by separating the background into the shadowless background region and the shadow region, and removes the shadow from the photographic image. Accordingly, shadows can be removed from photographic images without a background image, in which only the background is pictured.

### BRIEF DESCRIPTION OF THE DRAWINGS

FIG. 1 is a block diagram that illustrates the configuration of an ID card issuing system A, which is a first embodiment of the present invention.

FIG. 2 is a block diagram that illustrates the construction of an ID card generating center 50a, of the ID card issuing system A of FIG. 1.

FIG. 3 is a block diagram that illustrates the construction of a shadow detecting section 80a of the ID generating center 50a of FIG. 2.

FIG. 4 is a block diagram that illustrates the construction of a face detecting section 100 of the shadow detecting section 80a of FIG. 3.

FIGS. 5A and 5B illustrate edge detection filters, wherein FIG. 5A illustrates an edge detection filter for detecting horizontal edges, and FIG. 5B illustrates an edge detection filter for detecting vertical edges.

FIG. 6 is a diagram for explaining calculation of gradient vectors.

FIG. 7A illustrates a human face, and FIG. 7B illustrates gradient vectors in the vicinities of the eyes and the mouth within the human face.

FIG. 8A illustrates a histogram that represents magnitudes of gradient vectors prior to normalization, FIG. 8B illustrates a histogram that represents magnitudes of gradient vectors following normalization, FIG. 8C illustrates a histogram that represents magnitudes of gradient vectors, which has been divided into five regions, and FIG. 8D illustrates a histogram that represents normalized magnitudes of gradient vectors, which has been divided into five regions.

FIG. 9 illustrates examples of sample images, which are known to be of faces, employed during learning of first reference data E1, which is recorded in a second memory of the characteristic extracting portion.

FIGS. 10A, 10B, and 10C are diagrams for explaining rotation of faces.

FIG. 11 is a flow chart that illustrates the learning technique for reference data.

FIG. 12 illustrates a technique for selecting discriminators.

FIG. 13 is a diagram for explaining stepwise deformation of photographs during detection of faces by the characteristic extracting portion.

FIG. 14 is a flow chart that illustrates the processes performed by the ID card issuing system A of FIG. 1.

FIG. 15 is a block diagram that illustrates the configuration of an ID card issuing system B, which is a second embodiment of the present invention.

FIG. 16 is a block diagram that illustrates the construction of an ID card generating center 50b, of the ID card issuing system B of FIG. 15.

FIG. 17 is a block diagram that illustrates the construction of a shadow detecting section 80b of the ID generating center 50b of FIG. 16.

FIG. 18 is a flow chart that illustrates the processes performed by the ID card issuing system B of FIG. 15.

FIG. 19 is a first example of a facial image.

FIG. 20 is a second example of a facial image.

### DESCRIPTION OF THE PREFERRED EMBODIMENTS

Hereinafter, an embodiment of the present invention will be described with reference to the attached drawings.

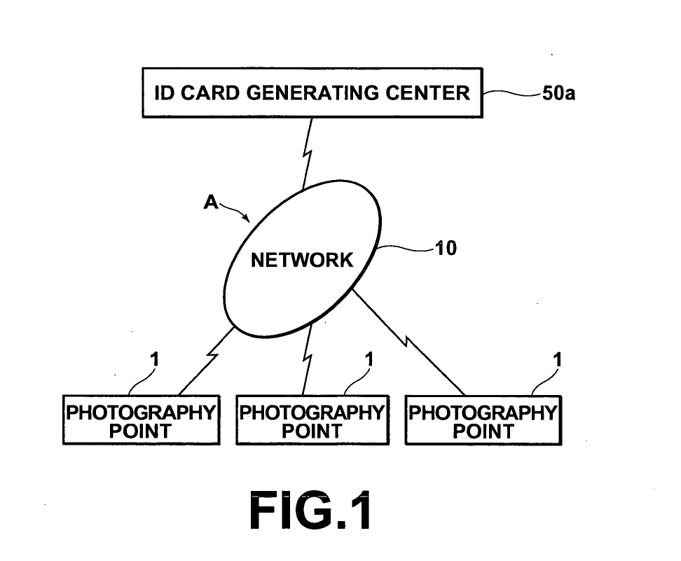

FIG. 1 is a block diagram that illustrates the configuration of an ID card issuing system A, which is a first embodiment of the present invention. The card issuing system A obtains facial images of people, for whom ID cards are to be generated, by photographing the people at a plurality of photography points 1. The obtained facial images are transmitted to an ID card generating center 50a (to be described later in detail). The ID card generating center 50a administers processes for removing shadows on the facial images, and generates photo ID cards. The shadow removing processes are realized by a computer (a personal computer, for example) executing a program read into an auxiliary memory device. The program may be recorded in a data recording medium such as a CD-ROM, or distributed via a network such as the Internet, and installed in the computer.

As illustrated in FIG. 1, the card issuing system A of the present embodiment comprises: the plurality of photography points 1, at which people for whom ID cards are to be generated are photographed to obtain the facial images; and the ID card generating center 50a, for generating ID cards employing the photographs obtained at the photography points 1. A network 10 connects each of the photography points 1 with the ID card generating center 50a. The facial images, which are obtained at the photography points 1, are transmitted to the ID card generating center 50a via the network 10.

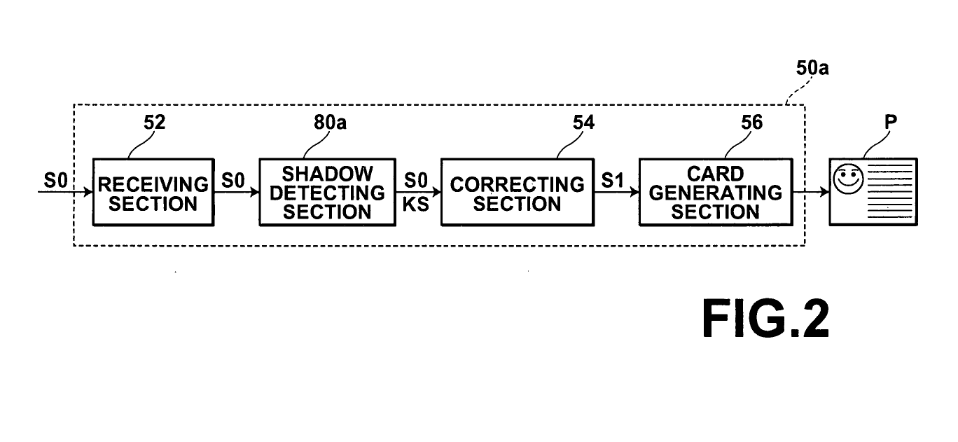

FIG. 2 is a block diagram that illustrates the construction of the ID card generating center 50a.

As illustrated in FIG. 2, the ID card generating center 50a comprises: a receiving section 52, for receiving the facial images S0 transmitted from each photography point 1; a shadow detecting section 80a, for detecting shadows within the facial images S0; a correcting section 54, for removing shadows detected by the shadow detecting section 80a to obtain corrected images S1; and a card generating section 56, for generating ID cards P after trimming processes, printing processes and the like are administered on the corrected images S1.

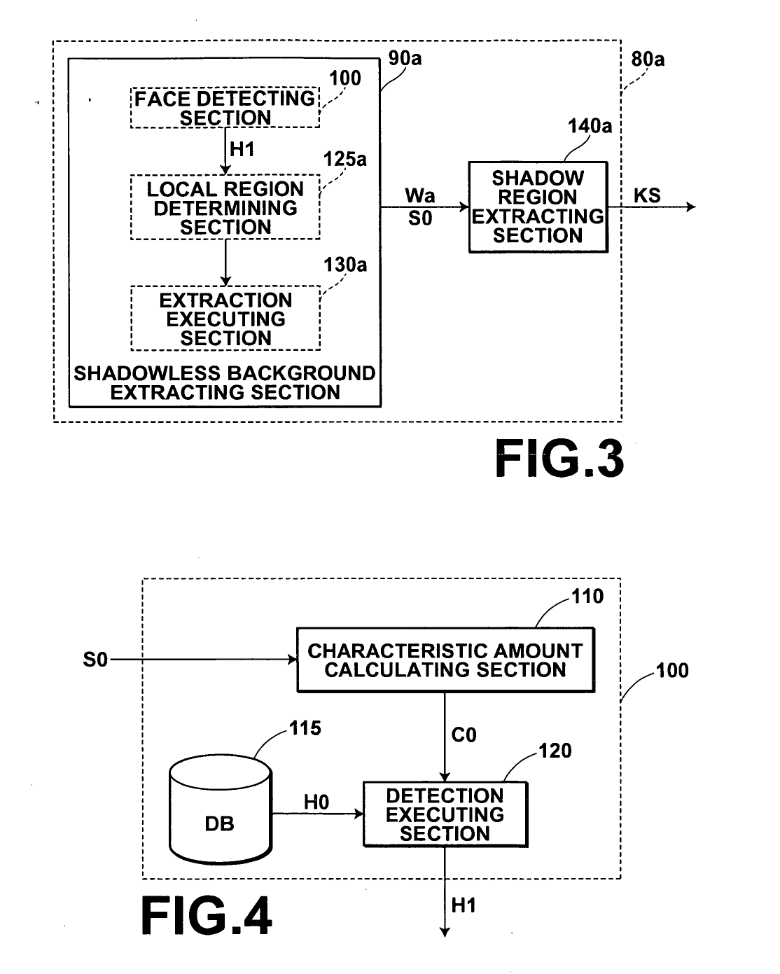

FIG. 3 is a block diagram that illustrates the construction of the shadow detecting section 80a of the ID generating center 50a. As illustrated in FIG. 3, the shadow detecting section 80a of the present invention comprises: a shadowless background region extracting section 90a, for extracting background regions in which shadows are not present, that is, shadowless background regions; and a shadow region extracting section 140a, for extracting shadow regions based on the extracted shadowless background regions. The shadowless background region extracting section 90a comprises: a face detecting section 100; a local region determining section 125a, and an extraction executing section 130a. First, each component of the shadowless region extracting section 90a will be described.

FIG. 4 is a block diagram that illustrates the detailed construction of the face detecting section 100 of the shadowless background region extracting section 90a. As illustrated in FIG. 4, the face detecting section 100 comprises: a characteristic amount calculating section 110, for calculating characteristic amounts C0 of the facial images S0; a database 115, in which reference data sets H0 to be described later are stored; and a detection executing section 120, for detecting facial regions from within the facial images S0, based on the characteristic amounts C0 calculated by the characteristic amount calculating section 110 and the reference data sets H0 stored in the database 115, and for obtaining data regarding the positions and sizes of the facial regions (hereinafter, referred to as “facial data H1).

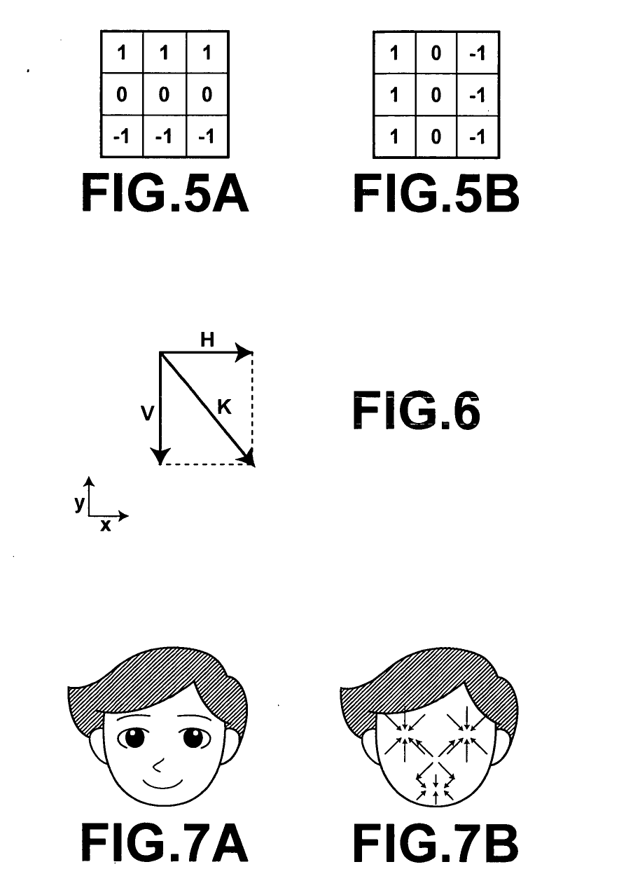

The characteristic amount calculating section 110 of the face detecting section 100 calculates the characteristic amounts C0, which are employed to discriminate faces, from the facial images S0. Specifically, gradient vectors (the direction and magnitude of density change at each pixel within the facial images S0) are calculated as the characteristic amounts C0. Hereinafter, calculation of the gradient vectors will be described. First, the characteristic amount calculating section 110 detects edges in the horizontal direction within a facial image S0, by administering a filtering process with a horizontal edge detecting filter, as illustrated in FIG. 5A. The characteristic amount calculating section 110 also detects edges in the vertical direction within the facial image S0, by administering a filtering process with a vertical edge detecting filter, as illustrated in FIG. 5B. Then, gradient vectors K for each pixel of the facial image S0 are calculated from the size H of horizontal edges and the size V of the vertical edges, as illustrated in FIG. 6.

In the case of a human face, such as that illustrated in FIG. 7A, the gradient vectors K, which are calculated in the manner described above, are directed toward the centers of eyes and mouths, which are dark, and are directed away from noses, which are bright, as illustrated in FIG. 7B. In addition, the magnitudes of the gradient vectors K are greater for the eyes than for the mouth, because changes in density are greater for the eyes than for the mouth.

The directions and magnitudes of the gradient vectors K are designated as the characteristic amounts C0. Note that the directions of the gradient vectors K are values between 0 and 359, representing the angle of the gradient vectors K from a predetermined direction (the x-direction in FIG. 6, for example).

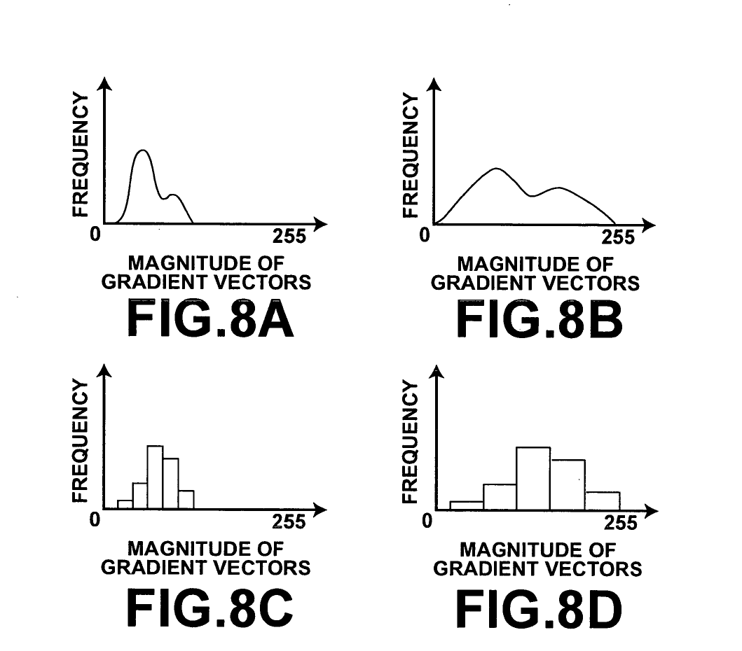

Here, the magnitudes of the gradient vectors K are normalized. The normalization is performed in the following manner. First, a histogram that represents the magnitudes of the gradient vectors K of all of the pixels within the facial image S0 is derived. Then, the magnitudes of the gradient vectors K are corrected, by flattening the histogram so that the distribution of the magnitudes is evenly distributed across the range of values assumable by each pixel of the candidate image (0 through 255 in the case that the image data is 8 bit data). For example, in the case that the magnitudes of the gradient vectors K are small and concentrated at the low value side of the histogram, as illustrated in FIG. 8A, the histogram is redistributed so that the magnitudes are distributed across the entire range from 0 through 255, as illustrated in FIG. 8B. Note that in order to reduce the amount of calculations, it is preferable that the distribution range of the gradient vectors K in a histogram be divided into five, for example, as illustrated in FIG. 8C. Then, the gradient vectors K are normalized by redistributing the histogram such that the frequency distribution, which has been divided into five, is distributed across the entire range of values from 0 through 255, as illustrated in FIG. 8D.

The reference data sets H0, which are stored in the database 115, defines discrimination conditions for combinations of the characteristic amounts C0 for each pixel of each of a plurality of types of pixel groups, which are constituted by a plurality of pixels selected from sample images, to be described later.

The combinations of the characteristic amounts C0 and the discrimination conditions within the reference data sets H0 are set in advance by learning. The learning is performed by employing a sample image group comprising a plurality of sample images, which are known to be of faces, and a plurality of sample images, which are known to not be of faces.

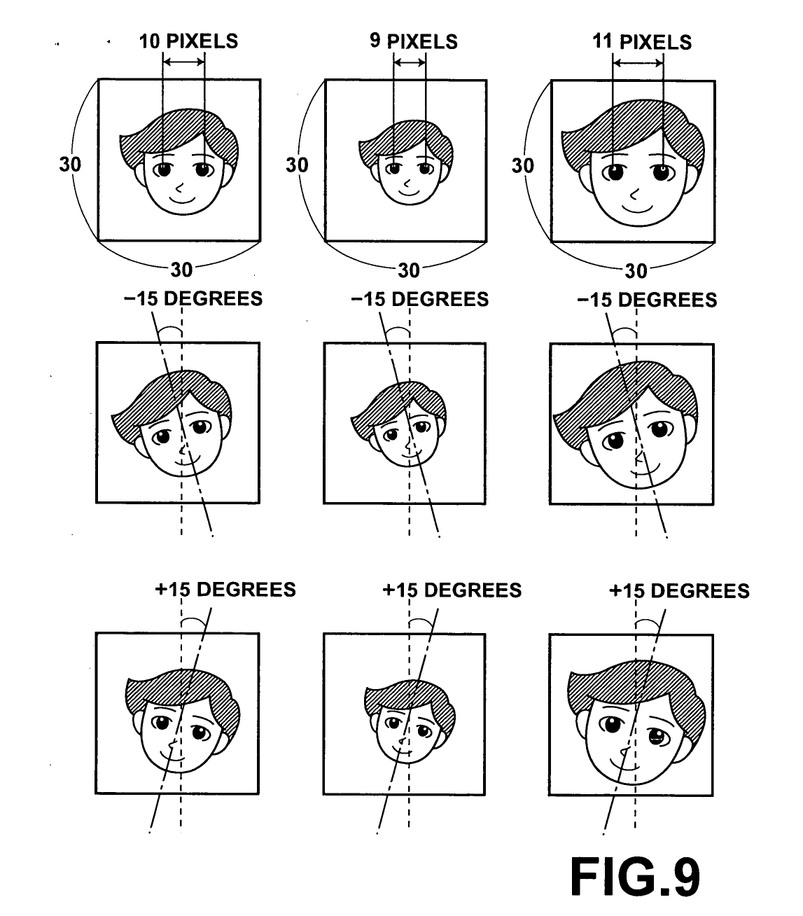

Note that in the present embodiment, the sample images, which are known to be of faces and are utilized to generate the reference data sets H0, have the following specifications. That is, the sample images are of a 30×30 pixel size, the distances between the centers of the eyes of each face within the images are one of 9, 10, or 11 pixels, and the faces are rotated stepwise in three degree increments within a range of ±15 degrees from the vertical (that is, the rotational angles are −15 degrees, −12 degrees, −9 degrees, −6 degrees, 0 degrees, 3 degrees, 6 degrees, 9 degrees, 12 degrees, and 15 degrees). Accordingly, 33 sample images (3×11) are prepared for each face. Note that only sample images which are rotated −15 degrees, 0 degrees, and 15 degrees are illustrated in FIG. 9. The centers of rotation are the intersections of the diagonals of the sample images. Here, if the distance between the eyes is 10 pixels in the sample images, then the central positions of the eyes are all the same. The central positions of the eyes are designated as (x1, y1) and (x2, y2) on a coordinate plane having the upper left corner of the sample image as its origin. The positions of the eyes in the vertical direction (that is, y1 and y2) are the same for all of the sample images.

Arbitrary images of a 30×30 pixel size are employed as the sample images which are known to not be of faces.

Consider a case in which sample images, in which the distance between the eyes are 10 pixels and the rotational angle is 0 degrees (that is, the faces are in the vertical orientation), are employed exclusively to perform learning. In this case, only those faces, in which the distance between the eyes are 10 pixels and which are not rotated at all, would be discriminated by referring to the reference data sets H0. The sizes of the faces, which are possibly included in the facial images S0, are not uniform in size. Therefore, during discrimination regarding whether a face is included in the photograph, the facial image S0 is enlarged/reduced, to enable discrimination of a face of a size that matches that of the sample images. However, in order to maintain the distance between the centers of the eyes accurately at ten pixels, it is necessary to enlarge and reduce the facial image S0 in a stepwise manner with magnification rates in 1.1 units, thereby causing the amount of calculations to be great.

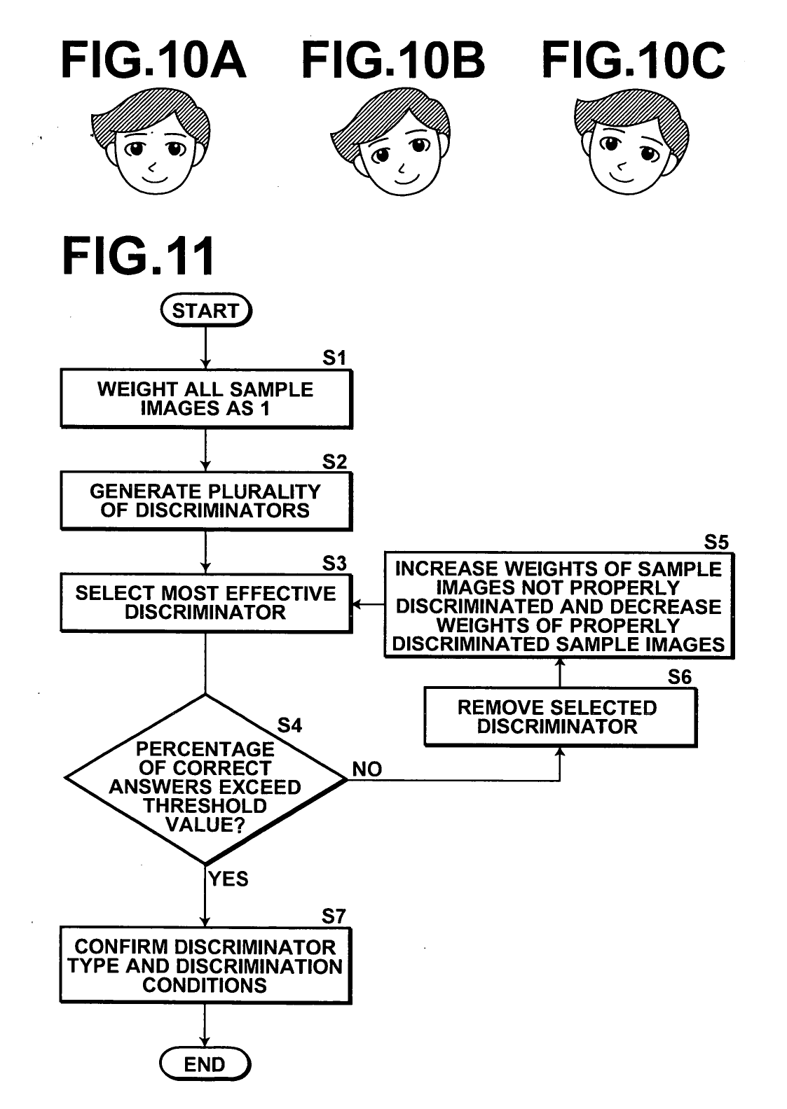

In addition, faces, which are possibly included in the facial images S0, are not only those which have rotational angles of 0 degrees, as that illustrated in FIG. 10A. There are cases in which the faces in the photographs are rotated, as illustrated in FIG. 10B and FIG. 10C. However, in the case that sample images, in which the distance between the eyes are 10 pixels and the rotational angle is 0 degrees, are employed exclusively to perform learning, rotated faces such as those illustrated in FIG. 10B and FIG. 10C would not be discriminated as faces.

For these reasons, the present embodiment imparts an allowable range to the reference data sets H0. This is accomplished by employing sample images, which are known to be of faces, in which the distances between the centers of the eyes are 9, 10, and 11 pixels, and which are rotated in a stepwise manner in three degree increments within a range of +15 degrees. Thereby, the facial image S0 may be enlarged/reduced in a stepwise manner with magnification rates in 11/9 units, which enables reduction of the time required for calculations, compared to a case in which the facial image S0 is enlarged/reduced with magnification rates in 1.1 units. In addition, rotated faces, such as those illustrated in FIG. 10B and FIG. 10C, are also enabled to be discriminated.

Hereinafter, an example of a learning technique employing the sample images will be described with reference to the flow chart of FIG. 11.

The sample images, which are the subject of learning, comprise a plurality of sample images, which are known to be of faces, and a plurality of sample images, which are known to not be of faces. Note that the in sample images, which are known to be of faces, the distances between the centers of the eyes of each face within the images are one of 9, 10, or 11 pixels, and the faces are rotated stepwise in three degree increments within a range of ±15 degrees from the vertical. Each sample image is weighted, that is, is assigned a level of importance. First, the initial values of weighting of all of the sample images are set equally to 1 (step S1).

Next, discriminators are generated for each of the different types of pixel groups of the sample images (step S2). Here, each discriminator has a function of providing a reference to discriminate images of faces from those not of faces, by employing combinations of the characteristic amounts C0, for each pixel that constitutes a single pixel group. In the present embodiment, histograms of combinations of the characteristic amounts C0 for each pixel that constitutes a single pixel group are utilized as the discriminators.

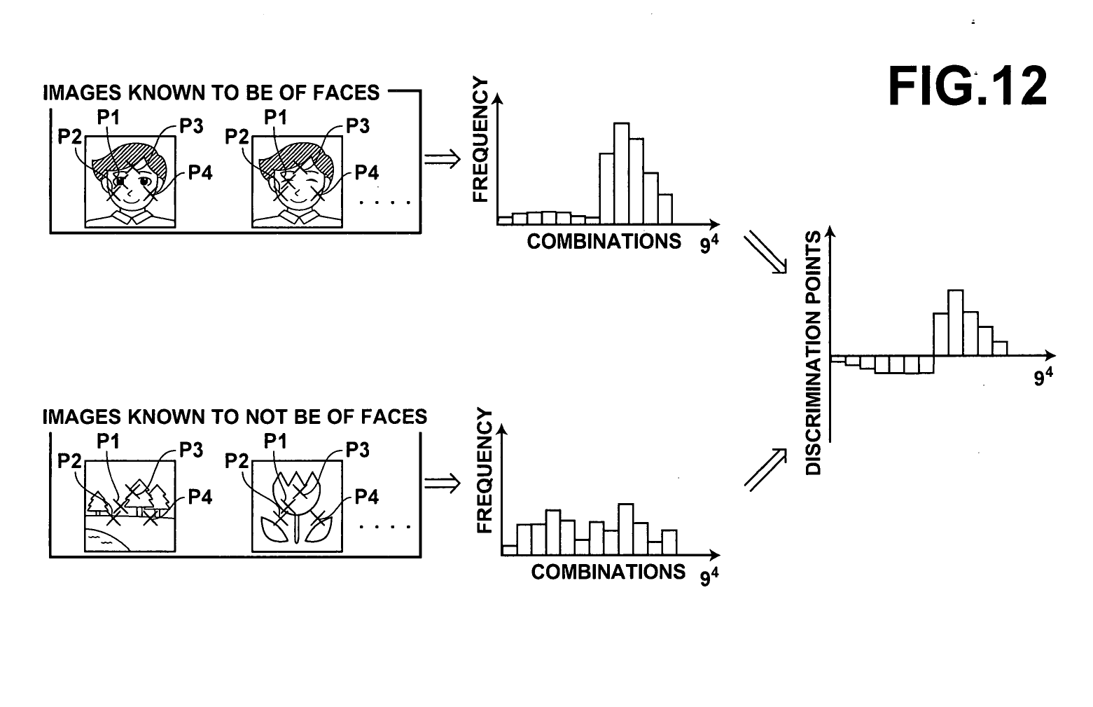

The generation of a discriminator will be described with reference to FIG. 12. As illustrated in the sample images at the left side of FIG. 12, the pixels that constitute the pixel group for generating the discriminator are: a pixel P1 at the center of the right eye; a pixel P2 within the right cheek; a pixel P3 within the forehead; and a pixel P4 within the left cheek, of the sample images which are known to be of faces. Combinations of the characteristic amounts C0 of the pixels P1 through P4 are obtained for all of the sample images, which are known to be of faces, and histograms thereof are generated. Here, the characteristic amounts C0 represent the directions and magnitudes of the gradient vectors K. However, there are 360 possible values (0 through 359) for the direction of the gradient vector K, and 256 possible values (0 through 255) for the magnitude thereof. If these values are employed as they are, the number of combinations would be four pixels at 360×256 per pixel, or (360×256)⁴, which would require a great number of samples, time, and memory for learning and detection. For this reason, in the present embodiment, the directions of the gradient vectors K are quaternarized, that is, set so that: values of 0 through 44 and 315 through 359 are converted to a value of 0 (right direction); values of 45 through 134 are converted to a value of 1 (upper direction); values of 135 through 224 are converted to a value of 2 (left direction); and values of 225 through 314 are converted to a value of 3 (lower direction). The magnitudes of the gradient vectors K are ternarized so that their values assume one of three values, 0 through 2. Then, the values of the combinations are calculated employing the following formulas.
Value of Combination=0 (in the case that the magnitude of the gradient vector is 0); and
Value of Combination=(direction of the gradient vector+1)×magnitude of the gradient vector (in the case that the magnitude of the gradient vector>0).

Due to the above quaternarization and ternarization, the possible number of combinations becomes 9⁴, thereby reducing the amount of data of the characteristic amounts C0.

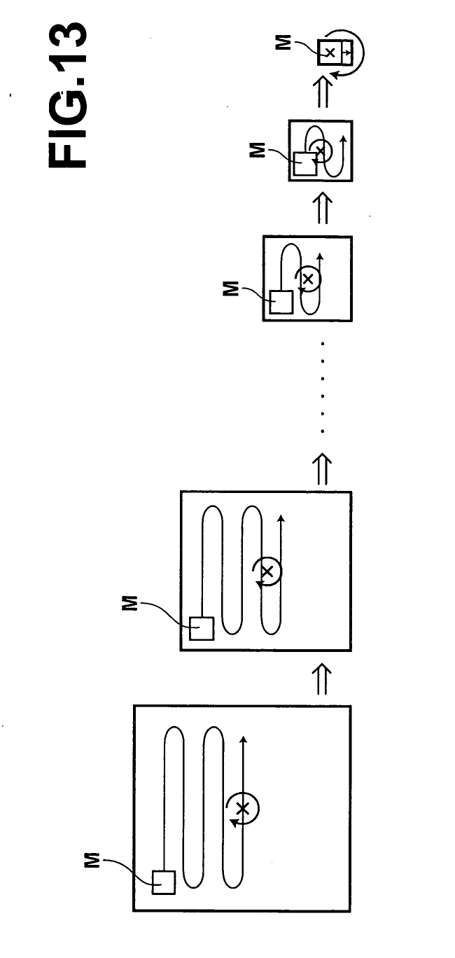

In a similar manner, histograms are generated for the plurality of sample images, which are known to not be of faces. Note that in the sample images, which are known to not be of faces, pixels (denoted by the same reference numerals P1 through P4) at positions corresponding to the pixels P1 through P4 of the sample images, which are known to be of faces, are employed in the calculation of the characteristic amounts C0. Logarithms of the ratios of the frequencies in the two histograms are represented by the rightmost histogram illustrated in FIG. 13, which is employed as the discriminator. According to the discriminator, images that have distributions of the characteristic amounts C0 corresponding to positive discrimination points therein are highly likely to be of faces. The likelihood that an image is of a face increases with an increase in the absolute values of the discrimination points. On the other hand, images that have distributions of the characteristic amounts C0 corresponding to negative discrimination points of the discriminator are highly likely to not be of faces. Again, the likelihood that an image is not of a face increases with an increase in the absolute values of the negative discrimination points. A plurality of discriminators are generated in histogram format regarding combinations of the characteristic amounts C0 of each pixel of the plurality of types of pixel groups, which are utilized during discrimination, in step S2.

Thereafter, a discriminator, which is most effective in discriminating whether an image is of a face, is selected from the plurality of discriminators generated in step S2. The selection of the most effective discriminator is performed while taking the weighting of each sample image into consideration. In this example, the percentages of correct discriminations provided by each of the discriminators are compared, and the discriminator having the highest weighted percentage of correct discriminations is selected (step S3). At the first step S3, all of the weighting of the sample images are equal, at 1. Therefore, the discriminator that correctly discriminates whether sample images are of faces with the highest frequency is selected as the most effective discriminator. On the other hand, the weightings of each of the sample images are renewed at step S5, to be described later. Thereafter, the process returns to step S3. Therefore, at the second step S3, there are sample images weighted with 1, those weighted with a value less than 1, and those weighted with a value greater than 1. Accordingly, during evaluation of the percentage of correct discriminations, a sample image, which has a weighting greater than 1, is counted more than a sample image, which has a weighting of 1. For these reasons, from the second and subsequent step S3's, more importance is placed on correctly discriminating heavily weighted sample images than lightly weighted sample images.

Next, confirmation is made regarding whether the percentage of correct discriminations of a combination of the discriminators which have been selected exceeds a predetermined threshold value (step S4). That is, the percentage of discrimination results regarding whether sample images are of faces, which are obtained by the combination of the selected discriminators, that match the actual sample images is compared against the predetermined threshold value. Here, the sample images, which are employed in the evaluation of the percentage of correct discriminations, may be those that are weighted with different values, or those that are equally weighted. In case that the percentage of correct discriminations exceeds the predetermined threshold value, whether an image is of a face can be discriminated by the selected discriminators with sufficiently high accuracy, therefore the learning process is completed. In the case that the percentage of correct discriminations is less than or equal to the predetermined threshold value, the process proceeds to step S6, to select an additional discriminator, to be employed in combination with the discriminators which have been selected thus far.

The discriminator, which has been selected at the immediately preceding step S3, is excluded from selection in step S6, so that it is not selected again.

Next, the weighting of sample images, which were not correctly discriminated by the discriminator selected at the immediately preceding step S3, is increased, and the weighting of sample images, which were correctly discriminated, is decreased (step S5). The reason for increasing and decreasing the weighting in this manner is to place more importance on images which were not correctly discriminated by the discriminators that have been selected thus far. In this manner, selection of a discriminator which is capable of correctly discriminating whether these sample images are of a face is encouraged, thereby improving the effect of the combination of discriminators.

Thereafter, the process returns to step S3, and another effective discriminator is selected, using the weighted percentages of correct discriminations as a reference.

The above steps S3 through S6 are repeated to select discriminators corresponding to combinations of the characteristic amounts C0 for each pixel that constitutes specific pixel groups, which are suited for discriminating whether faces are included in images. If the percentages of correct discriminations, which are evaluated at step S4, exceed the threshold value, the type of discriminator and discrimination conditions, which are to be employed in discrimination regarding whether images include faces, are determined (step S7), and the learning of the reference data sets H0 is completed.

Note that in the case that the learning technique described above is applied, the discriminators are not limited to those in the histogram format. The discriminators may be of any format, as long as they provide references to discriminate between images of faces and other images by employing combinations of the first characteristic amounts E1 of each pixel that constitutes specific pixel groups. Examples of alternative discriminators are: binary data, threshold values, functions, and the like. As a further alternative, a histogram that represents the distribution of difference values between the two histograms illustrated in the center of FIG. 13 may be employed, in the case that the discriminators are of the histogram format.

The learning technique is not limited to that which has been described above. Other machine learning techniques, such as a neural network technique, may be employed.

The detection executing section 120 refers to the discrimination conditions of the reference data sets H0, which has been learned regarding every combination of the characteristic amounts C0 of each pixel that constitutes a plurality of types of pixel groups. Thereby, the discrimination points of the combinations of the characteristic amounts C0 of each pixel that constitutes each of the pixel groups are obtained. A face is detected from the facial image S0 by totaling the discrimination points. At this time, of the characteristic amounts C0, the directions of the gradient vectors K are quaternarized, and the magnitudes of the gradient vectors K are ternarized. In the present embodiment, detection is performed based on the magnitude of the sum of all of the discrimination points, and whether the sum is positive or negative. For example, in the case that the total sum of the discrimination points is positive, it is judged that a face is included in the facial image S0. In the case that the total sum of the discrimination points is negative, it is judged that a face is not included in the facial image S0.

Here, the sizes of the facial images S0 are varied, unlike the sample images, which are 30×30 pixels. In addition, in the case that a face is included in the facial image S0, the face is not necessarily in the vertical orientation. For these reasons, the detection executing section 120 enlarges/reduces the facial image S0 in a stepwise manner (FIG. 13 illustrates a reduction process), so that the size thereof becomes 30 pixels in either the vertical or horizontal direction. In addition, the facial image S0 is rotated in a stepwise manner over 360 degrees. A mask M, which is 30×30 pixels large, is set on the facial image S0, at every stepwise increment of the enlargement/reduction. The mask M is moved one pixel at a time on the facial image S0, and whether a face is included in the facial image S0 is discriminated, by discriminating whether the image within the mask is that of a face (that is, whether the sum of the discrimination points obtained from the image within the mask M is positive or negative). The discrimination is performed at each step of magnification/reduction and rotation of the facial image S0. A 30×30 pixel size region corresponding to the position of the mask M at which the highest positive value is obtained for the sum of the discrimination points is detected as the facial region. The facial data H1 that indicates the position and the size of this region is output to the local region determining section 125a.

Note that during learning of the reference data sets H0, sample images are utilized, in which the distances between the centers of the eyes are one of 9, 10, and 11 pixels. Therefore, the magnification rate during enlargement/reduction of the facial image S0 may be set to be 11/9. In addition, during learning of the reference data sets H0, sample images are utilized, in which faces are rotated within a range of ±15 degrees. Therefore, the facial image S0 and the candidate may be rotated over 360 degrees in 30 degree increments.

Here, the characteristic amount calculating section 110 calculates the characteristic amounts C0 from the facial image S0 at each step of their stepwise enlargement/reduction and rotational deformation.

The face detecting section 100 of the shadow detecting section 80a obtains the facial data H1 that indicates the position and the size of a face within a facial image S0 in this manner.

The local region determining section 125a determines a portion of the shadowless background region within the facial image S0, based on the facial data H1. Specifically, advantage is taken of the fact that shadows are rarely formed above the face of a person who is the main subject, in the case of an ID photo. An arbitrary position (a point or a predetermined range) above the face is determined to be the local region, based on the position and the range (size) of the face indicated by the facial data H1. Note that in the case of ID photos, it is also rare for shadows to be formed above the central portion of the person's face. Therefore, an arbitrary position above the central portion of the face and excluding the facial region may be determined to be the local region. In the present embodiment, the local region determining section 125a determines the entire portion of the facial image S0 above the face to be the local region.

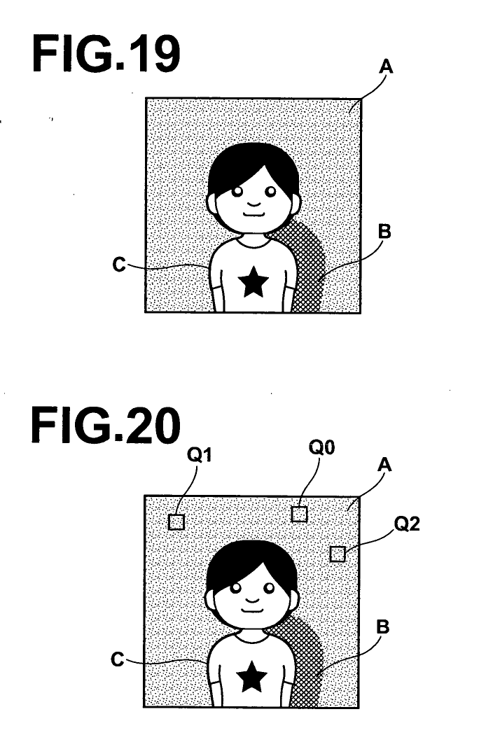

The extraction executing section 130a extracts the shadowless background region Wa based on the local region obtained by the local region determining section 125a. Specifically, first, the average color of pixels within the local region is calculated. In the present embodiment, an average hue, an average saturation, and an average brightness of the pixels within the local region are calculated. Next, the extraction executing section 130a detects regions adjacent to the local region and constituted by pixels, of which: the differences in the hue, the saturation, and the brightness from the average hue, the average saturation, and the average brightness of the local region are within predetermined threshold values, from regions of the facial image S0 other than the local region and the facial region. The detected regions and the local region are combined to extract the shadowless background region Wa. In the example illustrated in FIG. 19, Region A is extracted as the shadowless background region Wa.

The extraction executing section 130a outputs data indicating the shadowlesss background region Wa, data that indicates the positional range of the region Wa in this case, to the shadow region extracting section 140a. The shadow region extracting section 140a detects a region adjacent to the shadowless background region and constituted by pixels, of which: the differences in the hue and the saturation from the average hue and the average saturation of the local region are within predetermined threshold values; the brightness is lower than the average brightness of the local region; and the difference in the brightness from the average brightness of the local region is greater than a predetermined threshold value. The detected region is extracted as the shadow region KS.

The correcting section 54 administers processes for removing shadows from the facial image S0. Specifically, the correcting section 54 adjusts the brightness of the pixels within the shadow region KS such that they match the average brightness of the pixels within the local region. A corrected image S1 is obtained by correcting the brightness of each pixel within the shadow region KS in this manner.

Note that here, the correcting section 54 may obtain the average brightness of the pixels within the shadowless background region Wa, and adjust the brightness of each pixel within the shadow region KS to match the obtained average brightness. Alternatively, the brightness of each pixel within the shadowless background region Wa may be adjusted to match the brightness (average brightness) of pixels within the shadow region KS. As a further alternative, the brightness of each pixel in both the shadowless background region Wa and the shadow region KS may be adjusted to assume a uniform predetermined value.

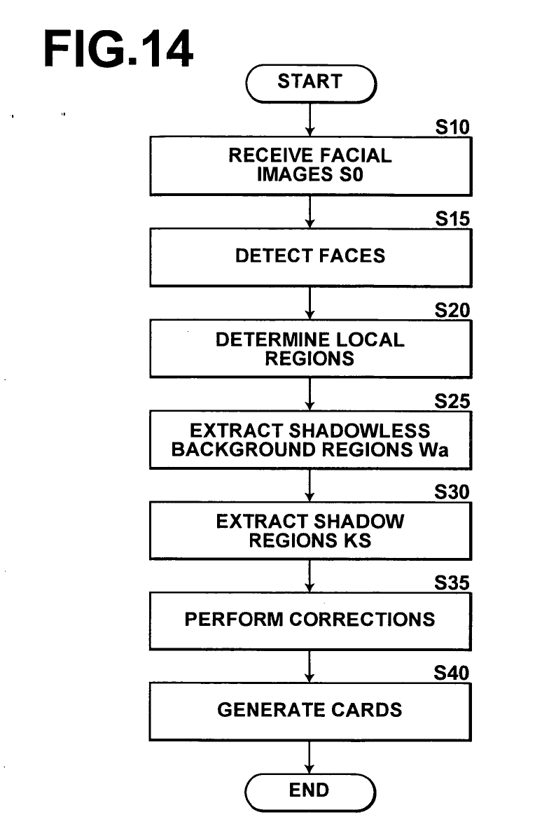

FIG. 14 is a flow chart that illustrates the processes performed at the ID card generating center 50a of the ID card issuing system A illustrated in FIG. 1. As illustrated in FIG. 14, the facial images S0 obtained at each photography point 1 are received by the receiving section 52 of the ID card generating center 50a (step S10). Facial regions are detected from within the facial images S0 by the face detecting section 100 of the shadowless background region extractins section 90a within the shadow detecting section 80a, and facial data H1 is obtained (step S15). The local region determining section 125a determines the portions of the facial images S0 above the faces to be the local regions, based on the facial data H1 (step S20). The extraction executing section 130a calculates the average hues, the average saturations, and the average brightnesses of pixels within the local regions, determined by the local region determining section 125a; detects regions adjacent to the local regions and constituted by pixels, of which: the differences in the hues, the saturations, and the brightnesses from the average hues, the average saturations, and the average brightnesses of the local regions are within predetermined threshold values; and extracts combinations of the detected regions and the local regions as the shadowless background regions Wa (step S25). In the example illustrated in FIG. 19, Region A is extracted as the shadowless background region Wa. The shadow region extracting means 140a detects regions adjacent to the shadowless background regions and constituted by pixels, of which: the differences in the hues and the saturations from the average hues and the average saturations of the local regions are within predetermined threshold values; the brightnesses are lower than the average brightnesses of the local regions; and the differences in the brightnesses from the average brightnesses of the local regions are greater than a predetermined threshold value; and extracts the detected regions as the shadow regions KS (step S30). The correcting section 54 obtains corrected images S1, by adjusting the brightnesses of the pixels within the shadow regions KS such that they match the average brightnesses of the pixels within the local regions (step S35). The card generating section 56 employs the corrected images S1 to generate the photo ID cards P (step S40).

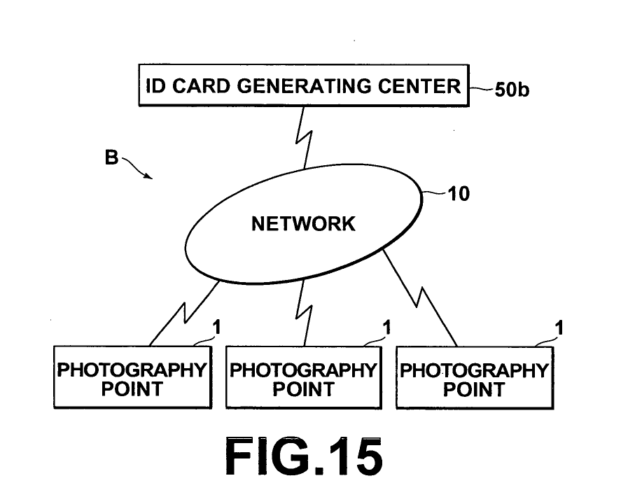

FIG. 15 is a block diagram that illustrates the configuration of an ID card issuing system B, which is a second embodiment of the present invention. As illustrated in FIG. 15, the card issuing system B of the present embodiment comprises: a plurality of photography points 1, at which people are photographed to obtain facial images; and an ID card generating center 50b, for generating ID cards employing the photographs obtained at the photography points 1. A network 10 connects each of the photography points 1 with the ID card generating center 50b. The facial images, which are obtained at the photography points 1, are transmitted to the ID card generating center 50b via the network 10.

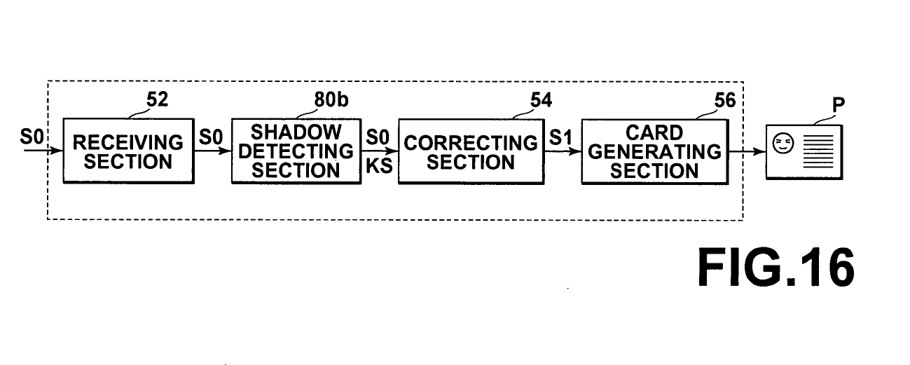

FIG. 16 is a block diagram that illustrates the construction of the ID card generating center 50b. Note that the ID card issuing system B differs from the ID card issuing system A illustrated in FIG. 1 only in the point that the construction of the ID card generating center 50b differs from that of the ID card generating center 50a. Therefore, a description will only be given regarding the ID card generating center 50b. In addition, components which are the same as those of the ID card issuing system A will be denoted with the same reference numerals.

As illustrated in FIG. 16, the ID card generating center 50b comprises: a receiving section 52, for receiving the facial images S0 transmitted from each photography point 1; a shadow detecting section 80b, for detecting shadows within the facial images S0; a correcting section 54, for removing shadows detected by the shadow detecting section 80b to obtain corrected images S1; and a card generating section 56, for generating ID cards P after trimming processes, printing processes and the like are administered on the corrected images S1.

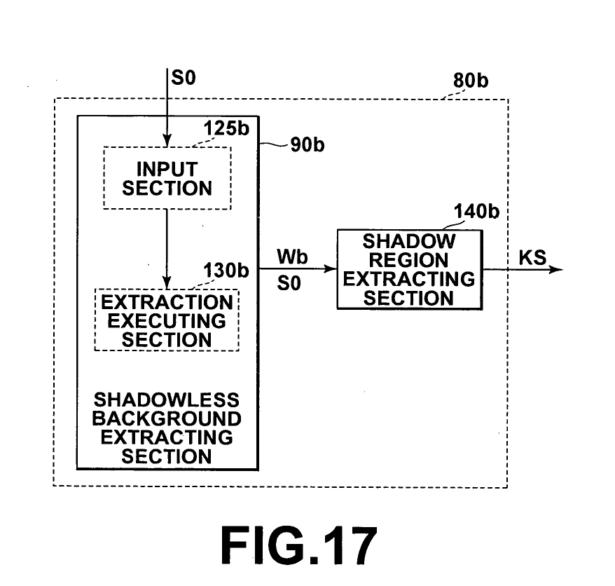

FIG. 17 is a block diagram that illustrates the construction of the shadow detecting section 80b of the ID card generating center 50b illustrated in FIG. 16. As illustrated in FIG. 17, the shadow detecting section 80b comprises: a background extracting section 90b; and a shadow region extracting section 140b. The background extracting section 90b comprises: an input section 125b; and an extraction executing section 130b.

The input section 125b enables a user to specify a “portion of the background at which shadows are not present”, that is, a local region, from within a facial image S0. The input section 125b comprises: a monitor for displaying the facial image S0; and a mouse or the like, for specifying the local region within an image (the facial image S0) displayed on the monitor. For example, the user may specify a local region indicated by Q0 in FIG. 20 as the local region via the input section 12b. Note that the local region is not limited to a single region. In the example illustrated in FIG. 20, Region Q1 and Region Q2 may be specified as the local region, in addition to Region Q0.

In the present embodiment, the input section 125b enables the user to specify a single local region. An example will be described for a case in which Region Q0 has been specified as the local region.

The extraction executing section 130b first calculates an average hue and an average saturation of pixels within Region Q0. Next, the extraction executing section 130b detects regions adjacent to Region Q0 and constituted by pixels, of which: the differences in the hue and the saturation from the average hue and the average saturation of Region Q0 are within predetermined threshold values. The detected regions and Region Q0 are combined to extract the background region Wb. In the examples illustrated in FIG. 19 and FIG. 20, the region constituted by Region A and Region B is extracted as the shadowless background region Wa.

The shadow region extracting section 140b extracts a shadow region KS, by separating the shadow region KS from the background region Wb. Specifically, the brightness of each pixel within the background region Wb is obtained, and a region constituted by pixels, of which: the brightness is lower than the average brightness of the local region Q0; and the difference in the brightness from the average brightness of the local region Q0 is greater than a predetermined threshold value is extracted as the shadow region KS.

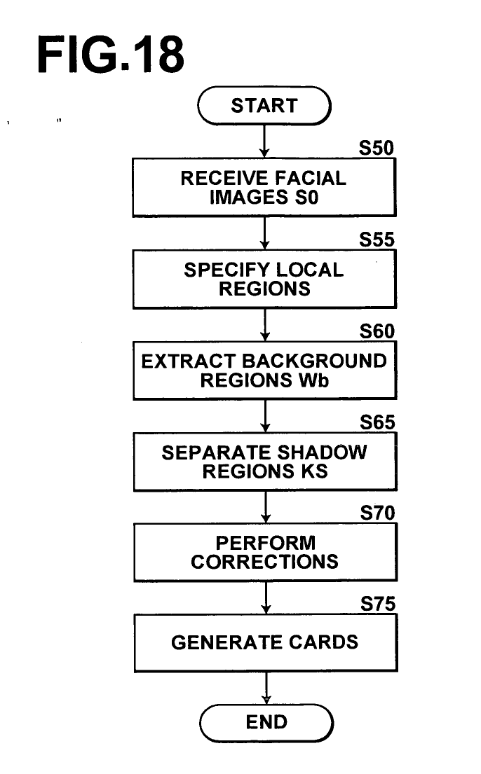

FIG. 18 is a flow chart that illustrates the processes performed at the ID card generating center 50b of the ID card issuing system B of the second embodiment. As illustrated in FIG. 18, the facial images S0 obtained at each photography point 1 are received by the receiving section 52 of the ID card generating center 50a (step S50). Local regions Q0 are specified within the facial images S0 via the input section 125b of the background extracting section 90b of the shadow detecting section 80b (step S55). The extraction executing section 130b calculates the average hues and the average saturations of pixels within the local regions Q0, specified in step S55; detects regions adjacent to the local regions Q0 and constituted by pixels, of which: the differences in the hues and the saturations from the average hues and the average saturations of the local regions Q0 are within predetermined threshold values; and extracts combinations of the detected regions and the local regions Q0 as the background regions Wb (step S60). In the examples illustrated in FIG. 19 and FIG. 20, the region constituted by Region A and Region B is extracted as the background region Wb. The shadow region extracting means 140b detects regions from within the background regions and constituted by pixels, of which: the brightnesses are lower than the average brightnesses of the local regions Q0; and the differences in the brightnesses from the average brightnesses of the local regions Q0 are greater than a predetermined threshold value; and separates the detected regions from the background regions Wb as the shadow regions KS (step S65). The correcting section 54 obtains corrected images S1, by adjusting the brightnesses of the pixels within the shadow regions KS such that they match the average brightnesses of the pixels within the local regions Q0 (step S70). The card generating section 56 employs the corrected images S1 to generate the photo ID cards P (step S75).

The ID card generating systems described in the embodiments above remove shadow regions from the facial images themselves when removing shadows. Therefore, shadows can be removed without background images, in which only backgrounds are pictured.

The preferred embodiments of the present invention have been described above. However, the present invention is not limited to the above embodiments. Various changes and modifications can be made as long as they do not depart from the spirit of the invention.

For example, in the case that the local region is determined by detecting the facial region from within the facial image, as in the ID card issuing system A of the first embodiment, any face detecting technique may be employed, as long as the position and the size of the face within the facial image can be obtained.

In addition, during extraction of the background region, the shadowless background region, and the shadow region, the color space is not limited to that of hue, saturation, and brightness. An RGB color space, a Lab color space, or the like may alternatively be employed.

What is claimed is:

1. An image processing apparatus for removing shadows of a main subject, from a photographic image in which the shadows are present within a background having a simple pattern, comprising:
shadowless background region extracting means for extracting a shadowless background region, in which the shadows are not present, from the photographic image;
shadow region extracting means for extracting a shadow region, from regions within the photographic image other than the shadowless background region; and
correcting means, for removing the shadows from the photographic image, by adjusting pixel values of the shadowless background region and/or the shadow region.

2. An image processing apparatus as defined in claim 1, wherein:
the shadow region extracting means extracts the shadow region from regions adjacent to the shadowless background region.

3. An image processing apparatus for removing shadows of a main subject, from a photographic image in which the shadows are present within a background having a simple pattern, comprising:
background region extracting means for extracting a background region, in which the shadows are present, from the photographic image;
shadow region extracting means for separating the extracted background region with shadows therein into a shadowless background region without shadows therein and a shadow region, in which the shadows are present; and
correcting means, for removing the shadows from the photographic image, by adjusting pixel values of the shadowless background region and/or the shadow region.

4. An image processing apparatus as defined in claim 1, wherein the shadowless background extracting means comprises:
local region obtaining means for obtaining a local region within the shadowless background region; and wherein:
the shadowless background region is extracted by obtaining regions adjacent to the obtained local region having pixels of similar colors to that of the local region, and by combining the local region with the adjacent regions.

5. An image processing apparatus as defined in claim 2, wherein the shadowless background extracting means comprises:
local region obtaining means for obtaining a local region within the shadowless background region; and wherein:
the shadowless background region is extracted by obtaining regions adjacent to the obtained local region having pixels of similar colors to that of the local region, and by combining the local region with the adjacent regions.

6. An image processing apparatus as defined in claim 3, wherein the background extracting means comprises:
local region obtaining means for obtaining a local region within a shadowless portion of the background region; and wherein:
the background region is extracted by obtaining regions adjacent to the obtained local region having pixels of similar colors to that of the local region, and by combining the local region with the adjacent regions.

7. An image processing apparatus as defined in claim 4, wherein:
the photographic image is an ID photograph of a human;
the local region obtaining means comprises face detecting means; and wherein:
the local region is obtained based on a facial region detected by the face detecting means.

8. An image processing apparatus as defined in claim 5, wherein:
the photographic image is an ID photograph of a human;
the local region obtaining means comprises face detecting means; and wherein:
the local region is obtained based on a facial region detected by the face detecting means.

9. An image processing apparatus as defined in claim 6, wherein:
the photographic image is an ID photograph of a human;
the local region obtaining means comprises face detecting means; and wherein:
the local region is obtained based on a facial region detected by the face detecting means.

10. An image processing apparatus as defined in claim 4, wherein the local region obtaining means comprises input means, for specifying the local region; and wherein:
the local region is obtained based on input, which is input via the input means.

11. An image processing apparatus as defined in claim 5, wherein the local region obtaining means comprises input means, for specifying the local region; and wherein:
the local region is obtained based on input, which is input via the input means.

12. An image processing apparatus as defined in claim 6, wherein the local region obtaining means comprises input means, for specifying the local region; and wherein:
the local region is obtained based on input, which is input via the input means.

13. An image processing apparatus as defined in claim 4, wherein:
the shadow region extracting means extracts regions, which have substantially the same hue and/or saturation as the shadowless region, and have lower brightnesses than the shadowless regions, as the shadow region.

14. An image processing apparatus as defined in claim 5, wherein:
the shadow region extracting means extracts regions, which have substantially the same hue and/or saturation as the shadowless region, and have lower brightnesses than the shadowless regions, as the shadow region.

15. An image processing apparatus as defined in claim 6, wherein:
the shadow region extracting means extracts regions, which have substantially the same hue and/or saturation as the shadowless region, and have lower brightnesses than the shadowless regions, as the shadow region.

16. A program that causes a computer to execute image processing for removing shadows of a main subject, from a photographic image in which the shadows are present within a background having a simple pattern, comprising the procedures of:
extracting a shadowless background region, in which the shadows are not present, from the photographic image;
extracting a shadow region, from regions within the photographic image other than the shadowless background region; and
removing the shadows from the photographic image, by adjusting pixel values of the shadowless background region and/or the shadow region.

17. A program as defined in claim 16, wherein:
the procedure for extracting the shadow region extracts the shadow region from regions adjacent to the shadowless background region.

18. A program that causes a computer to execute image processing for removing shadows of a main subject, from a photographic image in which the shadows are present within a background having a simple pattern, comprising the procedures of:
extracting a background region, in which the shadows are present, from the photographic image;
separating the extracted background region with shadows therein into a background without shadows therein and a shadow region, in which the shadows are present; and
removing the shadows from the photographic image, by adjusting pixel values of the shadowless background region and/or the shadow region.

19. An image processing apparatus for detecting shadows of a main subject, from a photographic image in which the shadows are present within a background having a simple pattern, comprising:
shadowless background region extracting means for extracting a shadowless background region, in which the shadows are not present, from the photographic image; and
shadow region extracting means for extracting a shadow region, from regions within the photographic image other than the shadowless background region.

20. An image processing apparatus for detecting shadows of a main subject, from a photographic image in which the shadows are present within a background having a simple pattern, comprising:
background region extracting means for extracting a background region, in which the shadows are present, from the photographic image; and
shadow region extracting means for separating the extracted background region with shadows therein into a shadowless background region without shadows therein and a shadow region, in which the shadows are present.

21. A computer readable recording medium, in which a program that causes a computer to execute image processing for removing shadows of a main subject, from a photographic image in which the shadows are present within a background having a simple pattern, the program comprising the procedures of:
extracting a shadowless background region, in which the shadows are not present, from the photographic image;
extracting a shadow region, from regions within the photographic image other than the shadowless background region; and
removing the shadows from the photographic image, by adjusting pixel values of the shadowless background region and/or the shadow region.

22. A computer readable recording medium as defined in claim 21, wherein:
the procedure for extracting the shadow region extracts the shadow region from regions adjacent to the shadowless background region.

23. A computer readable recording medium, in which a program that causes a computer to execute image processing for removing shadows of a main subject, from a photographic image in which the shadows are present within a background having a simple pattern, the program comprising the procedures of:
extracting a background region, in which the shadows are present, from the photographic image;
separating the extracted background region with shadows therein into a background without shadows therein and a shadow region, in which the shadows are present; and
removing the shadows from the photographic image, by adjusting pixel values of the shadowless background region and/or the shadow region.
